(19) United States
(12) Patent Application Publication
(10) Pub. No.: US 2018/0336122 A1
(43) Pub. Date: Nov. 22, 2018

(54) GENERATING APPLICATION FLOW ENTITIES

(71) Applicant: ENTIT SOFTWARE LLC, SANFORD, NC (US)

(72) Inventors: Olga Kogan, Yehud (IL); Amit Levin, Yehud (IL); IIan Shufer, Yehud (IL)

(21) Appl. No.: 15/778,073

(22) PCT Filed: Nov. 30, 2015
(86) PCT No.: PCT/US15/62914

§ 371 Date: May 22, 2018

(51) Int. Cl. G06F 11/36

(52) U.S. Cl. CPC G06F 11/3672

(57) ABSTRACT

Example implementations relate to generating application flow entities. Some implementations may include accessing a series of image frames from a test execution of an application and comparing, using an application test analysis device comprising a digital image processor, the image frames to each other to identify a subset of the image frames. The subset of image frames may be identified, for example, based on actions occurring during the test execution. Some implementations may also include automatically generating, using the application testing system, an application flow entity that represents the test. The application flow entity may be generated based on the subset of image frames.

### BACKGROUND

Applications may be developed for a wide range of computerized devices including individual computers, networked computer systems and mobile phones. Within each such context, applications may be developed for an even wider range of different uses. During development, an application or program may be tested, perhaps repeatedly, to ensure proper execution, identify and eliminate bugs and optimize usability. Developers may learn how to improve the application under development from these tests.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is a flowchart showing an example method of generating application flow entities consistent with disclosed implementations.

FIG. 2 is a flowchart showing an example method of generating application flow entities consistent with disclosed implementations.

FIG. 3 is a diagram showing an example method of generating application flow entities consistent with disclosed implementations.

FIGS. 4-6 are example illustrations of an application under test used to identify significant screens consistent with disclosed implementations.

FIG. 7 is an example illustration of an application test analysis device consistent with disclosed examples.

FIG. 8 is an example illustration of a system for generating application flow entities consistent with disclosed examples.

FIG. 9 is an example illustration of a non-transitory memory containing instructions for generating application flow entities consistent with disclosed examples.

Throughout the drawings, identical reference numbers designate similar, but not necessarily identical, elements.

### DETAILED DESCRIPTION

As indicated above, applications may be developed for many devices, in different contexts, to serve any number of uses. During development, applications may be tested, perhaps repeatedly, to ensure proper execution, identify and eliminate bugs and optimize usability. Developers may document and may compare different tests to learn how to improve the application.

One way of documenting an application test execution may be to make a video recording of the output of the application throughout the test. This may be done by recording the images on the screen or display device of a host system on which the application is being tested. Such a video recording may capture any actions that occur during the test that are echoed on, or output by the application to, the visual display. This will generally include receiving user input from a user input device, such as a keyboard of mouse, and the application's response to that user input.

While this video recording may document the test execution of the application, the video recording itself is unstructured data. Thus, a developer may need to watch the entire video recording to understand the application flow that occurred during the test execution. This may be cumbersome if the developer wants to more quickly understand the application flow or focus on a particular aspect of the text execution.

Additionally, the amount of data in the video recording can be significant. If multiple tests are executed to try various scenarios or compare executions under a single scenario, the volume of video data recorded may become cumbersome to store and manage.

To address these issues, implementations consistent with disclosed examples describe generating application flow entities. In some implementations, an application flow entity may represent each test execution of the application and, as will be described in more detail below, may allow a developer to more quickly and easily document and understand the application flow that occurred during a corresponding test execution of the application.

In the following description, for purposes of explanation, specific details are set forth in order to provide a thorough understanding of the disclosure. It will be apparent, however, to one skilled in the art that examples consistent with the present disclosure may be practiced without these specific details. Reference in the specification to “an implementation,” “an example” or similar language means that a particular feature, structure, or characteristic described in connection with the implementation or example is included in at least that one embodiment, but not necessarily in other embodiments. The various instances of the phrase “in one implementation” or similar phrases in various places in the specification are not necessarily all referring to the same embodiment.

As used herein and in the claims, the term test execution of an application refers to a test in which an application under test is executed on a host system, which could be any device capable of executing applications. The execution may include actions taken manually by a user, for example, as inputs to the application under test. The output from the application under test may be displayed on a screen or display device of the host system on which the test is being executed.

As used herein and in the claims, an application flow entity may be a collection of data that represents or documents a particular test execution of an application. However, the application flow entity is a smaller set of data than a full video record of the test execution so as to facilitate storage and analysis. In some implementations, the collection of data may be generated after the test execution of the application, and may include a portion of the data gathered during the test execution. For example, an application flow entity may include a number of image frames output during a test execution of an application and/or other information about a particular test execution of the application. For example, an application flow entity may include image frames identified as being significant screens in an application flow. As will be described below, in some implementations the application flow entity may have one or two tiers. For example, a one tier application flow entity may include image frame(s) identified as being significant screens in the application flow. As another example, a two tier application flow entity may include a second tier in which these significant screens have been grouped according to a corresponding application screen.

As used herein and in the claims, a “significant” frame may be a frame indicating an action occurring during the test execution of the application. The action may be an action of user input or responsive to user input or may be an action occurring from operation of the application independent of direct user input. An image of a significant screen may also be referred to as a “significant screen.”

As used herein and in the claims, an application screen may a screen output by the application under test. Various different actions may be taken on a single application screen before that screen is changed by the application. A change in application screen may occur, for example, when the application moves from one phase of operation to another and/or changes the graphical user interface presented to the user.

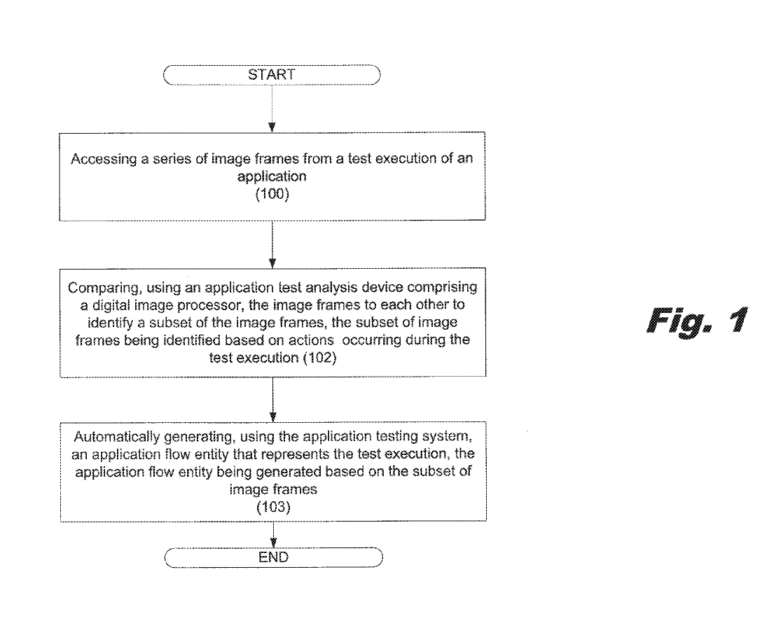

In an example of the principles disclosed herein, a method may include accessing a series of image frames from a test execution of an application; comparing, using an application test analysis device comprising a digital image processor, the image frames to each other to identify a subset of the image frames, the subset of image frames being identified based on actions occurring during the test execution; and automatically generating, using the application testing system, an application flow entity that represents the test execution, the application flow entity being generated based on the subset of image frames. A similar example will now be discussed further with respect to FIG. 1.

FIG. 1 is a flowchart showing an example method of generating application flow entities consistent with disclosed implementations. As described above, a test execution of an application may be performed to assist in the development of that application. The test produces a series of image frames that show the visual output of the application on a display device of the host system where the test was conducted.

This series of image frames can be generated in a number of ways. For example, a video camera can be used to video the display device of the host system during the test execution. In this case, the video feed used for subsequent analysis may be compressed by taking only one image frame every 50 milliseconds or at some other period and discarding intervening frames.

In another example, the host system may capture a screenshot of the output on its display device periodically. This might be every 50 milliseconds or some other interval. Additionally, this operation may include tuning the interval between the taking of screenshots based on application type or user behavior. For example, the interval between image frames can be tuned depending on the type of application under test or depending on the level of user activity solicited by the application. During period of relatively heavy user input or application output, image frames may be selected more frequently than at other periods during the test execution.

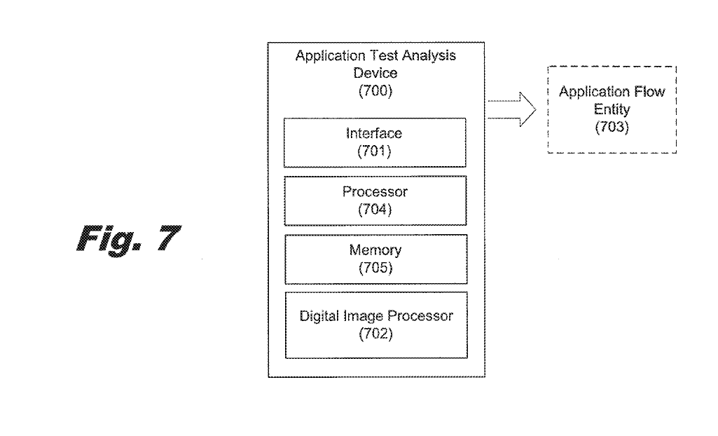

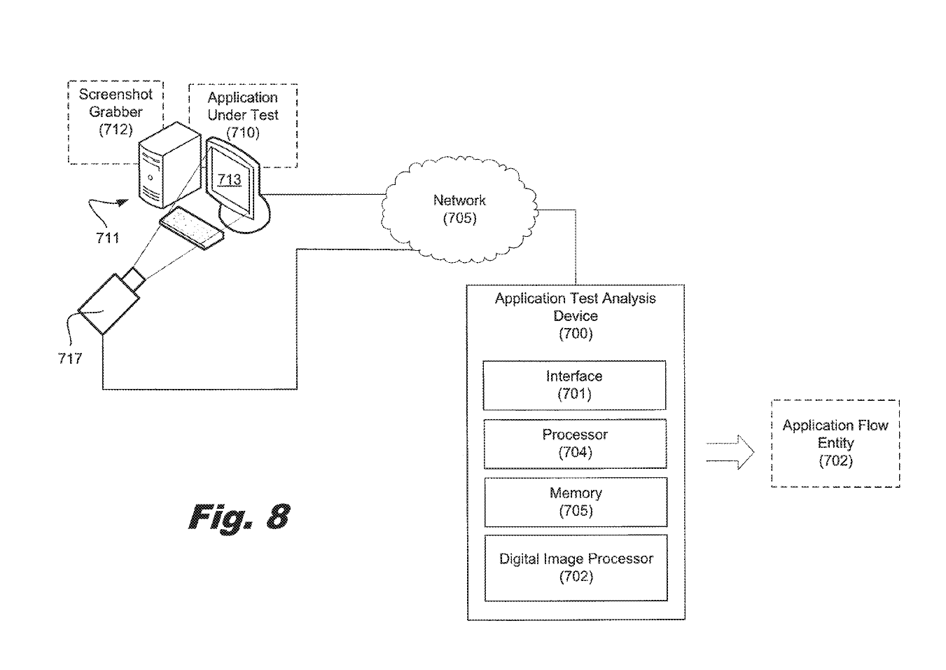

In some of these examples, a series of image frames may be produced from the test execution of the application. The method of claim 1 may include accessing (100) this series of image frames for analysis. This is explained in further detail below in FIGS. 7 and 8.

The images are compared (102). For example, each image is compared to the immediately preceding image in the series. This comparison is a “visual” comparison of the appearance one frame as against a subsequent frame. Though, this comparison is referred to as visual, it is performed electronically by comparing the digital image data for one frame against that of another. “Visual” comparison in this context is not meant to infer that a human user manually compares the appearance of two frames.

Through this comparison, a subset of image frames, i.e., only a fraction or less than the whole of the series of image frames, is selected. This subset of image frames may be the frames in which an action was occurring in the output of the application as shown on the display device of the host system.

During the test execution of the application, there will be actions that occur that are reflected in the visual output, such as a user entering input, the application responding, the application producing output, etc. In between these events, there will be times at which no action is occurring. For example, the application may be waiting for user input or maybe processing data without any output or change being made to the visual display. The subset of image fames selected will correspond to the points in time at which actions are occurring as reflected on the display device showing the visual output of the application, while image frames from the times between or apart from these moments of action will not be selected for the subset. The image frames documenting the actions that occurred during the test execution may be referred to as being “significant,” whereas image frames in which no action was occurring on the display device are not significant for purposes of understanding or documenting the test execution of the application. Examples of how the significant image frames may be identified are described below.

This subset of image frames may be used to generate (103) an application flow entity. In some implementations, an application flow entity may be an electronic collection of data that may include only the selected image frames from the test execution of the application. The application flow entity may include other data from the test execution of the application, such as a record of the user input entered, an identification of the host system and hardware and operating system environments, and other information characterizing that particular test execution.

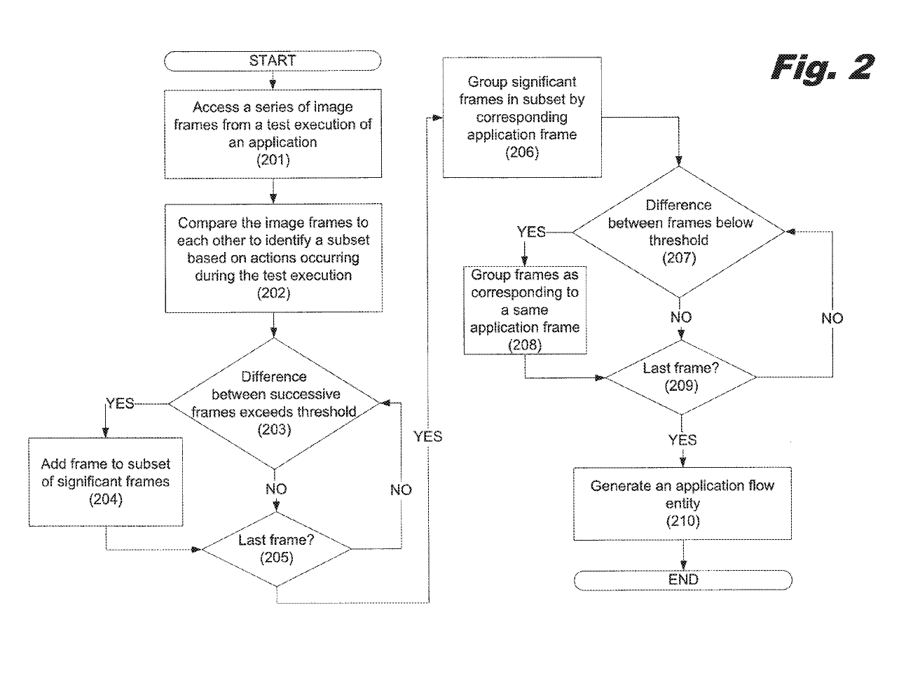

FIG. 2 is a flowchart showing an example method of generating application flow entities consistent with disclosed implementations. As will be described with regard to FIG. 2, the number of image frames used to generate an application flow entity may be further reduced from the number of frames identified as “significant.”

The method of FIG. 2 may include accessing (401) a series of image frames from a test execution of an application on a host system. The image frames may be compared (202) to identify a subset of significant image frames.

This may be done, for example, by quantifying a difference between the digital data for a first frame as compared to that of a second frame. For example, each pixel in a frame has numeric data that define the appearance, for example, the color, of the pixel. The pixel data for each frame can be evaluated to determine and to quantify how much that pixel data has changed between frames. This also quantifies a visual difference between the frames if presented on a display device. If there is no difference in the pixel data from frame to frame, the frames will appear identical when displayed. If something has changed in the image to be displayed, that change will be reflected in the pixel data. If this difference exceeds a threshold value (203), then the second or “changed” frame is designated as a “significant” frame and added (204) to the subset. Additionally or alternatively, a frame could be selected as “significant” based on an amount of user input, such as mouse moves or clicks, associated with that frame. When the last frame has been evaluated for significance (205), the process may advance.

The method may include determining which frames in the subset of image frames correspond to a same application screen from the application; and grouping together the image frames of the subset that correspond to a same application screen. With reference to FIG. 2, the method includes grouping (206) the frames in the subset of significant frames according to which frames come from the same corresponding application screen. During the operation of an application, a number of different screens may be presented. On any such screen, any number of actions might occur, for example, two different parameters input by a user to a single application screen. Each of those inputs would be an action occurring during the test execution. Each would be represented by an image frame considered “significant,” but both would correspond to the same application screen. If the application then presents a new screen, there may be a subsequent number of actions and significant frames associated with that next application screen.

Thus, in FIG. 2, the significant frames of the subset may be compared to determine which come from the same underlying application screen. This may be done by another “visual” comparison of those image frames. The difference between frames is quantified and compared. If the difference is below a threshold (207), this may indicate that the majority of the frames are identical, indicating that both come from the same underlying application screen. In this case, the frames may be grouped (208) as corresponding to a same application screen. This may continue until all the frames have been evaluated (209).

Each group of frames corresponding to a single application screen may be represented subsequently by the last-in-time frame from that group. The output is a second subset of image frames, each representing a group of frames from a common application screen in the subset of significant frames.

Using the subset of significant frames, an application flow entity is generated (210). This application flow entity may include both the subset of all significant frames and the smaller subset of significant frames each representing a group of frames from a common application screen. Alternatively, the application flow entity may include only the smaller subset of image frames. The smaller the application flow entity is, the more readily it can be stored and used in a subsequent analysis that compares different test executions of the application.

In summary of FIG. 2, an illustrate method includes accessing a series of image frames from a test execution of an application; comparing, using an application test analysis device comprising a digital image processor, the image frames to each other to identify a subset of the image frames, the subset of image frames being identified based on actions occurring during the test execution; and automatically generating, using the application testing system, an application flow entity that represents the test execution, the application flow entity being generated based on the subset of image frames. The method may include using the application flow entity by comparison with another application flow entity to evaluate different test executions of the application.

The subset of frames may be identified by comparing each frame to a previous frame in the series. This may be done by determining a degree of change between compared images from the series of image frames; and when the degree of change exceeds a threshold, adding a corresponding frame to the subset of image frames.

The method may further include determining which frames in the subset of image frames correspond to a same application screen from the application; and grouping together the image frames of the subset that correspond to a same application screen. This is done by comparing frames of the subset to each other to determine a difference between each pair of frames; and, when the difference between a pair of frames is below a threshold, assigning that pair of frames as corresponding to a same application screen. To further reduce the size of the data, the method may include representing an application screen with a last significant frame in the series that corresponds to that application screen.

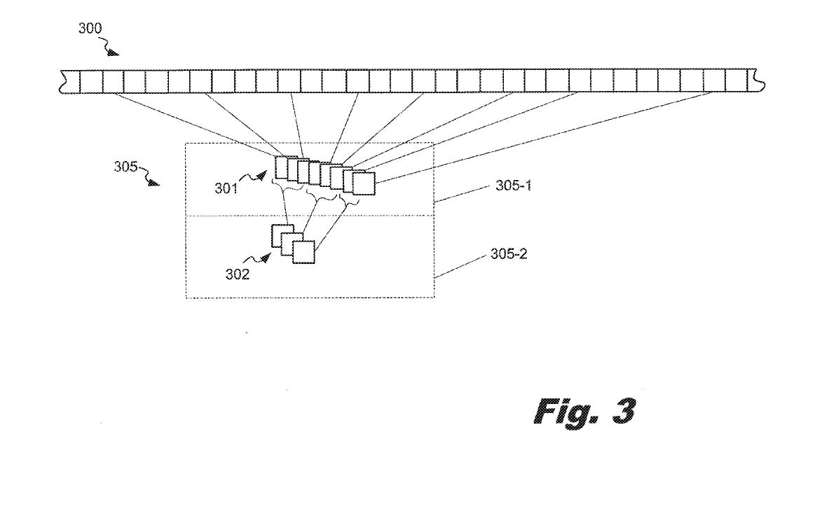

FIG. 3 is an illustration for showing an example method of generating application flow entities consistent with disclosed implementations. The method begins by accessing a stream or series of image frames (300) from a test execution of an application. As indicated above, this series of frames (300) may be video of the display device showing output from the application under test or a series of screenshots taken by the host device on which the application test is conducted. The host device and the production of the series of image frames (300) will be described below with reference to FIG. 8.

As shown in FIG. 3, some of these image frames are identified as being “significant,” meaning that they document an action occurring in the test of the application, such as user input, an application response to user input, or a development in the application's own process shown in the visual output of the application. The significant image frames are collected as a first subset (301). This, and the subsequent analysis, may be performed by the application test device described below with reference to FIG. 8.

These frames are grouped according to which show or correspond to the same underlying application screen. From each such group, a representative image frame may be taken to form a second subset (302). For example, the last-in-time frame from each group may be taken as the representative frame for that group to be included in the second subset (302).

An application flow entity (305) is generated based on the subsets of frames. The application flow entity (305) may be generated in several different ways depending on the needs and preferences of the application developer. For example, the application flow entity (305) may include both the first and second subsets of frames (301 and 302) along with or without other information, described herein, about the test execution of the application. In another example, an application flow entity (305-2) may only include the second subset of frames (302), with or without other information about the corresponding test execution of the application. This would application flow entity (305-2) would have the smallest size and demands on storage and processing resources. Lastly, the application flow entity (305-1) may include only the first subset of significant frames, with or without other information about the corresponding test execution of the application.

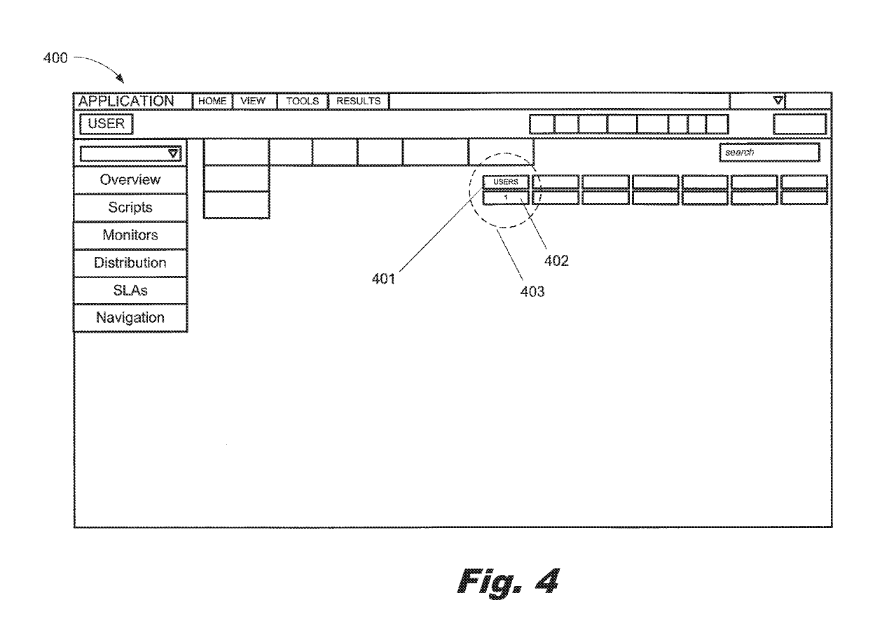

FIGS. 4-6 are example illustrations of an application under test used to identify significant screens consistent with disclosed implementations. With reference to FIG. 3, FIGS. 4-6 would represent three of the frames in the series (300).

In FIG. 4, an application screen (400) is imaged in the illustrated frame. Attention is drawn by the circle (403) in broken line to an input field of the application screen. The field is labeled “USERS” (401) with a corresponding box (402) in which a quantity of users can be specified. In the illustrated frame, that quantity is given as “1.”

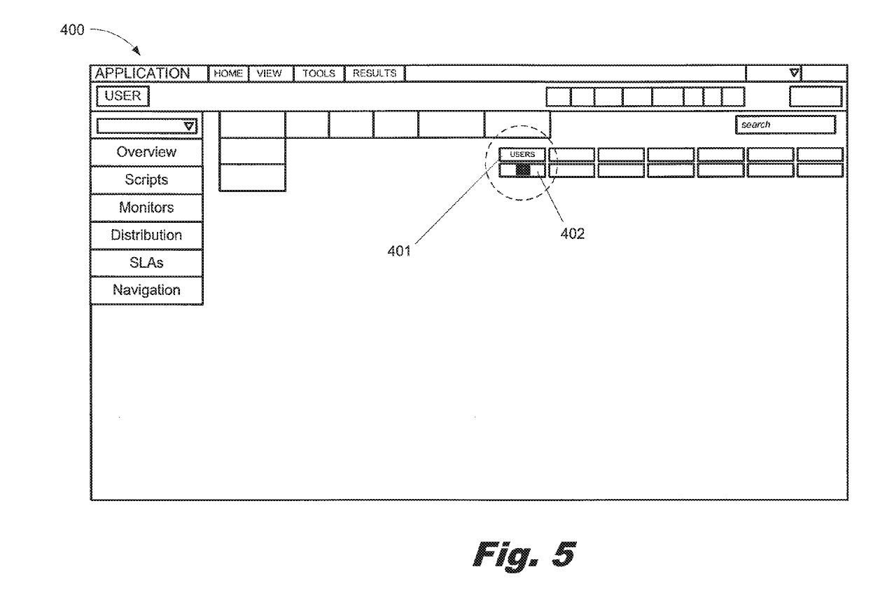

In a succeeding image frame, shown in FIG. 5, a change has occurred. The user has invoked a cursor in the box (402) so that the quantity specified can be changed. This user action is reflected in the visual output of the application by a cursor in the box (402). In FIG. 5, this cursor is shown as a highlight on the number in the box with the background and foreground colors reversed.

If the image frame of FIG. 4 were compared visually to that of FIG. 5, a change would be evident. In the digital data, this visual change would be indicated by the pixels representing the addition of the cursor, described above, changing to indicate the presence of the cursor. This visual change signals to the system that the image frame of FIG. 5 is “significant” because it records an action occurring, in this case, the user invoking a cursor to change the value in the “USERS” field.

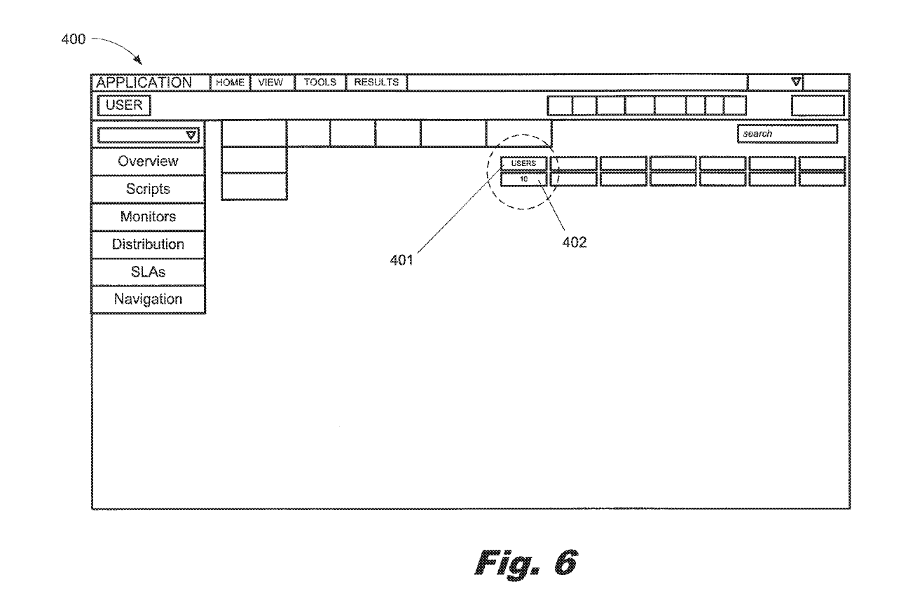

Next, in the image frame of FIG. 6, the user has entered a new value in the “USERS” field (402) of “10.” As before, if this image frame is compared to either of the earlier image frames, a visual difference will be detected in the pixels of the field or input box (402). Consequently, the image frame of FIG. 6 will be considered “significant” because it also records an action occurring in the test execution of the application, in this case, the change in the number of users specified to “10.”

Referring again to the example of FIG. 3, all the image frames of FIGS. 4-6 show and represent the same application screen, though in three different states. Accordingly, with reference to FIG. 3, the significant frames from FIGS. 4-6 would be identified as corresponding to the same underlying application screen and grouped together within the subset (301). If the second tier of analysis is being used, only one of them, for example, the last-in-time, would be selected for inclusion in the second subset (302).

FIG. 7 is an example illustration of an application test analysis device consistent with disclosed examples. As shown in FIG. 7, the example application test analysis device (700) includes an interface (701) for accessing a series of image frames from a test execution of an application; a processor (704) with associated memory (705); and a digital image processor (702) for comparing the image frames to each other to identify a subset of the image frames, the subset of image frames being identified based on actions occurring during the test execution. The processor will operate the interface, memory and digital image processor to implement the techniques described herein to generate an application flow entity (703) that represents the test execution, the application flow entity being generated based on the subset of image frames.

As described herein, the digital image processor is further to: determine which frames in the subset of image frames correspond to a same application screen from the application being tested; and group the image frames of the subset according to corresponding application screen. The application flow entity may include one representative image frame from each group of image frames.

FIG. 8 is an example illustration of a system for generating application flow entities consistent with disclosed examples. As shown in FIG. 8, a test of an application (710) is performed on a host system (711). In the illustrated example, the host system (711) is a computer including a monitor (713). However, as noted above, the host system could be any device capable of executing an application including, but not limited to, a laptop computer, tablet computer or smartphone.

The test of the application is recorded visually, as described above. In some examples, this may be done using a camera (717) which videos the display device (713) of the host system (711) throughout the test. Alternatively, the host system (711) may include a screenshot grabber (712) that periodically outputs a screenshot of the output on the display device (713) of the host system. The screenshot grabber (712) may be a software component running on the host device (711), for example, a browser plug-in or client application.

As described above, a series of image frames from the application test execution, either from the camera (717) to the screenshot grabber (712), are available to an application test analysis device that generates an application flow entity as described in the illustrated example, the host system (711) is a separate device from the application test analysis device (700) and provides the series of image frames to the application test analysis device (700) via a network (705). This network (705) could be any computer network, for example, the internet or a local area network at the facility of an application developer. However, the application test analysis device could alternatively be incorporated into the host system so as to be part of the system on which the test execution is performed.

Examples of the application test analysis device (700) may include hardware, or a combination of hardware and programming. In some examples, however, the application test analysis device could be implemented entirely in hardware.

The interface (701) may be, for example, a network interface to allow the device (700) to access the image frame series from the host system (711). The image frame series may be transmitted from the host system (711) to the application test analysis device (700) directly. Alternatively, the image frame series may be archived at some network-accessible location from which the test analysis device (700) retrieves the image frame series using the interface (701).

The digital image processor (702) may be a dedicated graphics processing unit (GPU). Alternatively, the digital image processor (702) may be a general processor specifically programmed to perform various aspects of the methods described above.

The digital image processor (702) compares frames from the series of image frames output by the host system (711). This comparison may be, as described above, to determine a first subset of significant image frames from among the series of image frames from the host system (711). Additionally, the comparison may be, as described above, to group significant image frames according to a corresponding application screen.

The application test analysis device (700) outputs an application flow entity (703). Various different examples of the application flow entity are described above. The application flow entity (703) is much easier to store and use in analysis than would be the entire stream of image frames from the host system (711). The application flow entity (703) records a particular test execution of the application under test (710) and can be used to understand that test execution and compare that test execution to other test executions, including those using the same or a different test scenario or script.

In other examples, the host system could be a computer system owned and operated by a non-professional application tester operating remotely. This approach, called crowd testing, allows an application developer to pay anyone to test certain flows manually on, for example, a per hour basis or per defect found basis. In such examples, the application developer provides the volunteer tester with a testing client or browser plug-in that will run on the tester's machine to provide the functionality of the host device (711) described herein. For example, the testing client or browser plug-in may provide the screen grabber described herein that returns screenshots of the application test execution to the application developer for analysis as described above.

In other examples, such a client or browser plug-in could be used by a machine after the application has actually been deployed in a real production environment. This may be desired when the actual production environment or specific uses cases are too complex or expensive to reproduce in a lab test setting, yet further analysis and debugging of the application are still needed.

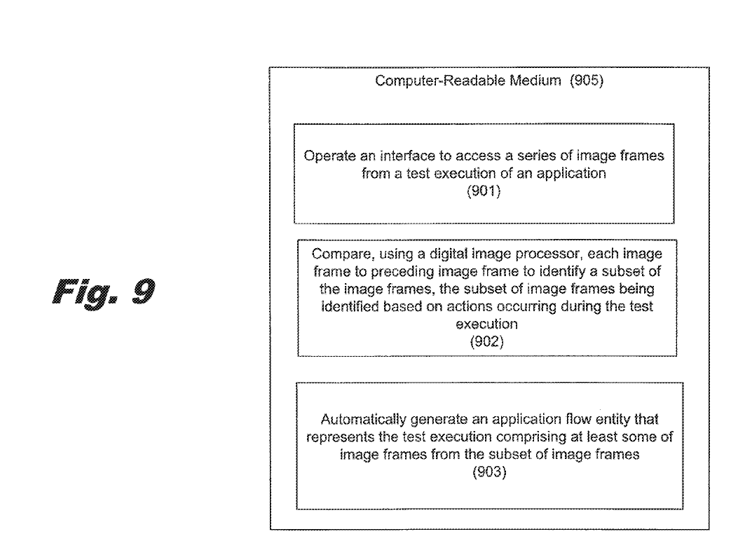

FIG. 9 is an example illustration of a non-transitory computer-readable medium containing instructions for generating application flow entities consistent with disclosed examples. In the illustrated example, a computer-readable medium (905) contains comprising instructions that, when executed, cause a processor of an application test analysis device to: operate (901) an interface to access a series of image frames from a test execution of an application; compare (902), using a digital image processor, each image frame to preceding image frame to identify a subset of the image frames, the subset of image frames being identified based on actions occurring during the test execution; and, automatically generate (903) an application flow entity that represents the test execution comprising at least some of image frames from the subset of image frames. The instructions may also determine which frames in the subset of image frames correspond to a same application screen from the application being tested; and group the image frames of the subset according to corresponding application screen.

A non-transitory computer-readable medium may include, for example, a hard-drive, a solid-state drive, or any other device from which instructions can be read by a processor, including Random Access Memory and other forms of volatile memory. In some examples, the computer readable medium (905) may be the memory device (705) shown in FIG. 7 in the application test analysis device.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method, comprising:
accessing a series of image frames from a test execution of an application;
comparing, using an application test analysis device comprising a digital image processor, the image frames to each other to identify a subset of the image frames, the subset of image frames being identified based on actions occurring during the test execution; and
automatically generating, using the application testing system, an application flow entity that represents the test execution, the application flow entity being generated based on the subset of image frames.

2. The method of 1, further comprising:
determining which frames in the subset of image frames correspond to a same application screen from the application; and
grouping together the image frames of the subset that correspond to a same application screen.

3. The method of claim 2, further comprising:
comparing frames of the subset to each other to determine a difference between each pair of frames; and
when the difference between a pair of frames is below a threshold, assigning that pair of frames as corresponding to a same application screen.

4. The method of claim 3, further comprising representing an application screen with a last significant frame in the series that corresponds to that application screen.

5. The method of claim 1, further comprising generating the series of image frames by making a video recording of output on a display of a computer on which the test execution was conducted.

6. The method of claim 1, further comprising generating the series of image frames by periodically taking screenshots from a screen receiving an output of the test execution of the application.

7. The method of claim 6, further comprising tuning an interval between taking of screenshots based on application type or user behavior.

8. The method of claim 1, further comprising comparing each frame in the series of image frames to a previous frame in the series.

9. The method of claim 8, wherein identifying the subset of image frames comprises:
determining a degree of change between compared images from the series of image frames; and
when the degree of change exceeds a threshold, adding a corresponding frame to the subset of image frames.

10. The method of claim 1, further comprising using the application flow entity by comparison with another application flow entity to evaluate different test executions of the application.

11. An application test analysis device, comprising:
an interface for accessing a series of image frames from a test execution of an application;
a processor with associated memory; and
a digital image processor for comparing the image frames to each other to identify a subset of the image frames, the subset of image frames being identified based on actions occurring during the test execution;
the processor to operate the interface, memory and digital image processor to generate an application flow entity that represents the test execution, the application flow entity being generated based on the subset of image frames.

12. The device of 11, wherein the digital image processor is further to:
determine which frames in the subset of image frames correspond to a same application screen from the application being tested; and
group the image frames of the subset according to corresponding application screen.

13. The device of claim 12, wherein the application flow entity comprises one representative image frame from each group of image frames.

14. A non-transitory computer-readable medium, the computer-readable medium comprising instructions that, when executed, cause a processor of an application test analysis device to:
operate an interface to access a series of image frames from a test execution of an application;
compare, using a digital image processor, each image frame to preceding image frame to identify a subset of the image frames, the subset of image frames being identified based on actions occurring during the test execution; and
automatically generate an application flow entity that represents the test execution comprising at least some of image frames from the subset of image frames.

15. The computer program product of 14, further comprising instructions that, when executed, cause the application test analysis device to:
determine which frames in the subset of image frames correspond to a same application screen from the application being tested; and
group the image frames of the subset according to corresponding application screen.
